(19) United States
(12) Patent Application Publication
(10) Pub. No.: US 2013/0188802 A1
(43) Pub. Date: Jul. 25, 2013

(54) HEADSET WITH TWO INTERFACES

(71) Applicant: Chia-Chung LIN, Taichung City (TW)

(72) Inventor: Chia-Chung LIN, Taichung City (TW)

(73) Assignee: MERRY ELECTRONICS CO., LTD., TAICHUNG CITY (TW)

(21) Appl. No.: 13/354,379

(22) Filed: Jan. 20, 2012

(51) Int. Cl. H04R 1/10

(52) U.S. Cl. 381/74

(57) ABSTRACT

A headset includes a microphone, a speaker, two interfaces and a controller. The interfaces are adapted to transmit first and second sound signals, which are outputted by first and second devices respectively to the controller. A third sound signal outputted by the microphone is also transmitted to the controller. The controller has a router planned with sound signal paths, which enables transmittance of the third sound signal to the second device and transmittance of the first and second sound signals to the speaker simultaneously. Therefore, the user can hear the sounds from the devices at the same time and have a conversation by means of the second device.

### BACKGROUND OF THE INVENTION

1. Field of the Invention The present invention relates generally to headsets and more particularly, to a headset with two interfaces, which can receive sound signals outputted from two devices.

2. Description of the Related Art

The conventional headset is generally provided with only one interface for communicating with one sound signal outputting device, such as music player, video player, computer, cellphone, and so on.

When using a headset to listen to music or sounds from a video or an online game, the user may miss an important phone call because the headset can't receive the sound signal from the cellphone at the same time. Besides, it's very inconvenient for the user to take off the headset before answering the phone call and put on the headset again after ending the phone conversation. Therefore, it is desired to provide a headset that enables its user to answer the phone call and listen to music at the same time.

### SUMMARY OF THE INVENTION

The present invention has been accomplished in view of the above-noted circumstances. It is an objective of the present invention to provide a headset with two interfaces, which can receive sound signals from two devices at the same time and allow the user to choose at least one of the devices for conversation.

To attain the above objective, the present invention provides a headset for simultaneously receiving a first sound signal from a first device and a second sound signal from a second device. The headset comprises a microphone, a speaker, a first interface for communicating with the first device, a second interface for communicating with the second device, and a controller including a router planned with sound signal paths and communicated with the microphone, the speaker and the first and second interfaces for receiving the first and second sound signals and a third sound signal from the microphone and transmitting the third sound signal to the second device through the second interface. The router has a first node for receiving the first and second sound signals simultaneously and transmitting the first and second sound signals to the speaker. As a result, the speaker can emit sounds converted from the signals outputted from the first and second devices at the same time so that the user can hear those sounds at the same time and can have a conversation by means of the microphone and the second device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not !imitative of the present invention, and wherein:

FIG. 1 is a schematic view of a headset provided by a preferred embodiment of the present invention;

FIG. 2 is a simplified block diagram of the headset provided by the preferred embodiment of the present invention; and

FIG. 3 is similar to FIG. 2, but showing an alternate form of the sound signal paths planned by a router of a controller.

### DETAILED DESCRIPTION OF THE INVENTION

First of all, it is to be mentioned that same reference numerals used in the following preferred embodiments and the appendix drawings designate same or similar elements throughout the specification for the purpose of concise illustration of the present invention. Besides, when it is mentioned that an element communicates with another element, it means that the former element is directly communicated with the latter element, or the former element is indirectly communicated with the latter element through one or more other elements between aforesaid former and latter elements.

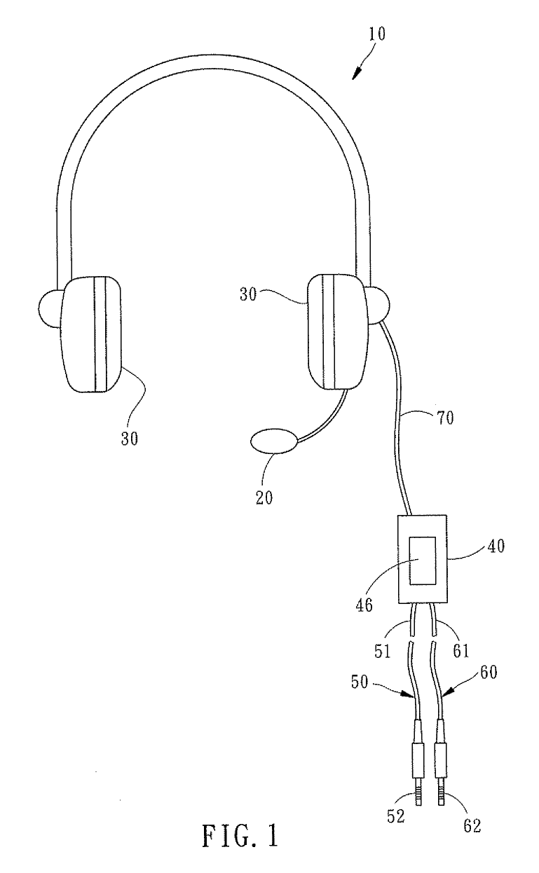

As shown in FIG. 1, a headset 10, which is provided by a preferred embodiment of the present invention, comprises a microphone 20, two speakers 30, a controller 40, a first interface 50 and a second interface 60.

The headset 10 is adapted for being worn on a user's head in such a way that the microphone 20 is located at a place near the user's mouth and the speakers 30 correspond to the user's ears respectively. It will be appreciated that a headset having a single microphone and a single speaker can be used as the headset 10 of the present invention.

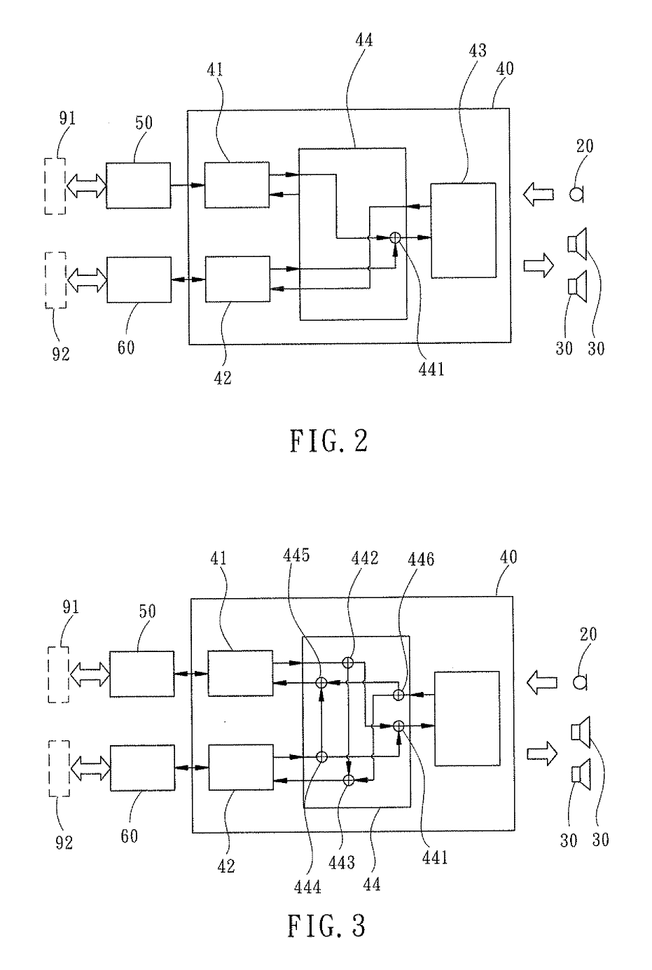

The controller 40 communicates with the microphone 20 and the speakers 30 through a wire 70. The first and second interfaces 50, 60 communicate with the controller 40 through wires 51, 61 respectively and are provided with connecting jacks 52, 62 for respectively inserting into first and second devices 91, 92 (as shown in FIGS. 2-3). Each of the devices 91, 92 can be any kind of sound signal outputting device, such as music player, video player, computer or cellphone.

By aforesaid communicating relationship, first and second sound signals outputted from the first and second devices 91, 92 respectively are transmitted to the controller 40 through the first and second interfaces 50, 60 respectively. Meanwhile, the microphone 20 can output a third sound signal converted from sounds that the user generate to the controller 40. It will be appreciated that the first and second interfaces 50, 60 can be wireless signal transmitting interfaces that communicate with the first and second devices 91, 92 wirelessly. Besides, the controller 40 can communicate with the microphone 20 and the speakers 30 in a wireless way by using, but not limited to, Bluetooth® technology.

As shown in FIGS. 2-3, the controller 40 includes first, second and third processors 41, 42, 43 and a router 44. The first processor 41 is communicated between the first interface 50 and the router 44 and the second processor 42 is communicated between the second interface 60 and the router 44. The third processor 43 is communicated between the microphone 20 and the router 44 and between the speakers 30 and the router 44. The processors 41, 42, 43 are adapted for adjusting sound signals, e.g. for filtering, amplitude adjusting, analog to digital converting, and digital to analog converting. The router 44 is planned with sound signal paths, which can be the form shown in FIG. 2 or 3.

When the sound signal paths planned in the router 44 have a form as shown in FIG. 2, the first and second sound signals, which are respectively adjusted by the first and second processors 41, 42, are mixed at a first node 441 of the router 44, and then transmitted to the speakers 30 after they are further adjusted by the third processor 43. After adjusted by the third processor 43, the third sound signal is transmitted to the second processor 42 by the router 44 for further adjustment, and then transmitted to the second device 92 through the second interface 60.

In practice, the first device 91 can be a computer with an on-going online game, and the second device 92 can be a cellphone. When playing the online game and receiving a phone call on the cellphone at the same time, the user can answer the phone call by means of the microphone 20 and the speakers 30, so the user doesn't have to take off the headset 10. Meanwhile, the user can carry on the online game and receive the sounds from it by means of the speakers 30. In other words, the user can have a conversation by means of the microphone 20, the speakers 30 and the second device 92 and receive sounds from the first and second devices 91, 92 at the same time.

The controller 40 can weaken the first sound signal by the first processor 41 so that the speakers 30 emit sounds, which are mixed with a first sound converted from the first sound signal, and a second sound converted from the second sound signal and having a volume greater than that of the first sound. Therefore, when the user answers the phone call, the sound from the online game can be reduced to become a background sound, thereby avoiding interference with the phone conversation.

The controller 40 may comprise an operating panel 46 for being operated by the user to optionally minimize the volume of the first sound corresponding to the first sound signal so as to enable the first sound to become a background sound under the condition that the controller 40 receives the first and second sound signals at the same time. The operating panel 46 may comprise either a screen and several buttons or just buttons. Alternatively, the operating panel 46 can be a touch panel. Otherwise, the controller 40 can be set to reduce the first sound signal automatically when receiving the first and second sound signals at the same time so that the operating panel 46 is unnecessary.

When the sound signal paths planned in the router 44 have a form as shown in FIG. 3, the first sound signal is received by a second node 442 of the router 44 after it is adjusted by the first processor 41 and then transmitted by the second node 442 to the first node 441 and a third node 443. The second sound signal is received by a fourth node 444 of the router 44 after it is adjusted by the second processor 42 and then transmitted by the fourth node 444 to the first node 441 and a fifth node 445. The third sound signal is received by a sixth node 446 of the router 44 after it is adjusted by the third processor 43 and then transmitted by the sixth node 446 to the third node 443 and the fifth node 445. The first and second sound signals are mixed at the first node 441 and then transmitted to the speakers 30 after they are further adjusted by the third processor 43. The first and third sound signals are mixed at the third node 443 and then transmitted to the second interface 60 after they are further adjusted by the second processor 42. The second and third sound signals are mixed at the fifth node 445 and then transmitted to the first interface 50 after they are further adjusted by the first processor 41. As a result, the user can have a tripartite conversation by means of the microphone 20, the speakers 30 and the first and second devices 91, 92.

As same as the aforesaid first example, the first device 91 can be a computer with an on-going online game, and the second device 92 can be a cellphone. When playing the online game and receiving a phone call on the cellphone at the same time, the user can answer the phone call by means of the microphone 20 and the speakers 30, so the user doesn't have to take off the headset 10. Meanwhile, the user can carry on the online game and have a conversation with another game player by means of the microphone 20 and the speakers 30, and the person on the phone can also join the conversation, achieving a tripartite conversation.

The operating panel 46 can be operated by a user to alternatively select the sound signal paths planned by the router 44 between the form of FIG. 2 where the headset 10 is set in a simultaneously listening mode and the form of FIG. 3 where the headset 10 is set in a tripartite conversation mode. Otherwise, the controller 40 may have no such operating panel 46, and the sound signal paths planned in the router 44 are fixedly set as shown in FIG. 2 so that the headset 10 only has the simultaneously listening mode or as shown in FIG. 3 so that the headset 10 only has the tripartite conversation mode.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A headset for receiving a first sound signal from a first device and a second sound signal from a second device at the same time, comprising:
a microphone;
a speaker;
a first interface for communicating with the first device;
a second interface for communicating with the second device; and
a controller including a router planned with sound signal paths and communicated with the microphone, the speaker and the first and second interfaces for receiving the first and second sound signals and a third sound signal from the microphone and transmitting the third sound signal to the second device through the second interface, the router having a first node for receiving the first and second sound signals simultaneously and transmitting the first and second sound signals to the speaker.

2. The headset as claimed in claim I, wherein the controller further comprises a first processor for signal adjustment; the first processor is communicated between the first interface and the router.

3. The headset as claimed in claim 2, wherein the first processor of the controller weakens the first sound signal such that the speaker emits a first sound converted from the first sound signal and a second sound converted from the second sound signal and having a volume greater than that of the first sound,

4. The headset as claimed in claim 1, wherein the controller further comprises a second processor for signal adjustment; the second processor is communicated between the second interface and the router.

5. The headset as claimed in claim 1, wherein the controller further comprises a third processor for signal adjustment; the third processor is communicated between the microphone and the router and between the speaker and the router.

6. The headset as claimed in claim 1, wherein the router of the controller further comprises second, third, fourth, fifth and sixth nodes; the second node is adapted for receiving the first sound signal and transmitting the first sound signal to the first and third nodes; the fourth node is adapted for receiving the second sound signal and transmitting the second sound signal to the first and fifth nodes; the sixth node is adapted for receiving the third sound signal and transmitting the third sound signal to the third and fifth nodes; whereby the controller transmits the first and third sound signals to the second interface simultaneously and transmits the second and third sound signals to the first interface simultaneously.

7. The headset as claimed in claim 6, wherein the controller comprises an operating panel for being operated by a user to select a simultaneously listening mode where the speaker emits a first sound converted from the first sound signal and a second sound converted from the second sound signal simultaneously and the microphone is communicated with the second device or a tripartite conversation mode which enables the user to have a tripartite conversation by means of the headset and the first and second devices.
